(19) United States
(12) Patent Application Publication
(10) Pub. No.: US 2018/0057086 A1
(43) Pub. Date: Mar. 1, 2018

(54) Motorcycle Jack

(71) Applicant: Basil Paul Andrews, Mississauga (CA)

(72) Inventor: Basil Paul Andrews, Mississauga (CA)

(21) Appl. No.: 15/561,255

(22) PCT Filed: Mar. 16, 2016
(86) PCT No.: PCT/CA2016/050295

§ 371 Date: Sep. 25, 2017

Related U.S. Application Data
(63) Continuation of application No. 14/669,328, filed on Mar. 26, 2015, now abandoned.

(30) Foreign Application Priority Data
Mar. 25, 2015 (CA) 2886714
Sep. 25, 2015 (CA) 2905661

(51) Int. Cl. B62H 3/00; B25H 1/00

(52) U.S. Cl. CPC B62H 3/00; B25H 1/0014

(57) ABSTRACT

A portable motorcycle jack is provided comprising a base arm and a lift arm hingedly joined for folding the two components together. The base arm has a foot that rests co-planar with the ground when in use. The lift arm is hingedly joined to the base arm at base end and has a cradle for engaging the motorcycle at an cradle end.

In another aspect, the base arm has a plurality of apertures arranged linearly and sloped relative to the base arm to provide adjustment in length of the motorcycle jack while maintaining the over-fulcrum angle of the base arm relative to the lift arm regardless of which length is selected.

### FIELD OF INVENTION

This invention relates generally to motorcycle jacks and more particularly to portable motorcycle jacks.

### BACKGROUND OF THE INVENTION

Motorcycles are typically manufactured with a side kickstand on which the motorcycle rests when not in use along with resting on the front and rear tires of the motorcycle. This resting position tilts the motorcycle to the side of the kickstand but also locks the front and rear tires in place. Commonly, such motorcycles require periodic maintenance such as chain cleaning, lubrication, adjustment, and tire or wheel inspecting, among other maintenance procedures. To perform such inspection and maintenance, the rear wheel is raised off the ground so the rear wheel may spin freely. This maintenance often needs to be performed away from a garage, for example, while away from home during a ride.

Mechanisms for raising a motorcycle's rear wheel are !mown. Typically, however, such mechanisms are over-sized, not portable, not easily adjustable, not compactly stored, or less stable than desired. Additionally, such mechanisms may not be economically fabricated.

More compact lifting mechanisms are also known. For example, U.S. Pat. No. 7,188,854 B1 in the name of Pickens (“Pickens”) teaches a collapsible motorcyclejack comprising a base arm, a lift arm, pivotable attaching means interconnecting an upper end of the base arm with a lower end of the lift arm, and a motorcycle engaging means fixedly attaching to the upper end of the lift arm. FIG. 1a is a perspective view illustrating the Pickens device. Thus, the Pickens device, is comprised of three basic elements joined together to be placed opposite the kickstand for raising the motorcycle rear wheel. In use, the motorcycle engaging means is inserted into a passage through a rear axle of the motorcycle, the base arm contacts. the ground, and pivoting the device towards the motorcycle rear wheel in conjunction with and opposite the kickstand lifts the rear wheel of the motorcycle. When pivoted towards the motorcycle, the unit “locks” in place to keep raised the rear wheel of the motorcycle. Such a unit, however, suffers from stability issues. Any force the user exerts on the motorcycle for maintenance can jar the motorcycle engaging means, a stepped insert, out of place. The angle of the lift arm relative to the base arm is fairly close to 180 degrees, affecting the stability of the device, providing very little locking force. Moreover, the small contact point with the swingarm of the motorcycle and the small contact point with the ground makes the device less stable than would otherwise be desired. In particular, the edge on which the device rests when in use results in rocking of the device as work is being done leading to instability and unlocking of the device. Furthermore, some motorcycles with tubular axles, particularly ones with single-sided swingarms are configured so that the axle rotates with the wheel. Use of the Pickens device with such arrangements will prevent rotation of the axle and in turn the wheel as a result of frictional engagement between the axle and the non-rotatable motorcycle engaging means. Still furthermore, some manufacturers cap the end of the tubular axle preventing insertion of the motorcycle engaging means.

U.S. Pat. No. 8,480,059 B2 in the name of Hunt (“Hunt”) teaches a collapsible adjustable motorcycle jack comprising a base arm hingedly connected to a lifting arm via a pin and spacers. FIG. 1b is a perspective view illustrating the Hunt device. The base arm rests on the ground, and the lifting al m engages with the motorcycle. Hunt also teaches raising the rear wheel of the motorcycle by pivoting the device at its hinge toward the rear wheel of the motorcycle. Similarly, this device suffers from stability issues. The lifting arm engages with the motorcycle in a small “V” cut out or other concave shape to contact with a lifting point on the motorcycle, such as an end of a rear axle or a rear axle securing nut. Often, the rear axle securing nut is narrow, approximately a quarter to a half an inch, providing a small contact point and further providing metal to metal contact point. This can also lead to scratching and other damage to the nut or threads on the axle. Moreover, manufacturers' attachment of other devices to the nut renders this device unusable without modifications from the user. Finally, the base arm has a small contact point with the ground, relying on a corner of the base to gain a foothold.

Accordingly, a motorcycle jack is desired that overcomes at least one of the above disadvantages.

### SUMMARY OF THE INVENTION

The present disclosure provides a portable motorcycle jack supporting a front or rear wheel of the motorcycle. The motorcycle jack has a U channel base arm having a web and two side flanges. A lift arm defined by a body has a base end and a cradle end. At the base end, the lift arm is hingedly attached to the two side flanges of the base arm providing a hinged joint. The cradle end of the lift arm has a cradle rotatably attached for engaging the motorcycle. In one embodiment, the cradle is rotatably attached to said cradle end of said lift arm for engaging a swing arm on the motorcycle and accommodating various degrees of swing arm angles.

A pivot pin mounts the lift arm within the base arm for hinged movement between a folded position in which the lift arm is contained within the base arm and a hyper-extended position in which the lift arm moves over the hinged joint to extend outwardly from the base arm to an over-fulcrum angle defined by the relative position of the longitudinal axis of the lift arm to the longitudinal axis of the base arm for supporting the rear wheel of the The base arm also has a foot rotatably attached thereto for accommodating various surface configurations of the ground on which the foot may rest when in use. In another embodiment, the cradle has an insertable portion for insertion into a passage extending into an axle of the motorcycle. The insertable portion includes a head rotatably attached thereto for supporting the axle for rotation along with said wheel.

In another embodiment, the present disclosure provides a portable motorcycle jack for supporting a front or rear wheel of a motorcycle. The portable motorcycle jack has a base arm hingedly connected at one end to a lift arm at a base end of the base arm for hinged rotation between a folded non-deployed position and a deployed position in which the lift arm and the base arm define an over-fulcrum angle to maintain the portable motorcycle jack in the deployed configuration in response to a weight of the motorcycle acting on a cradle end of the lift arm which is opposite said base end. A cradle is connected to the cradle end for supporting the swing arm of the motorcycle, and a foot on the base arm opposite the one end is configured to rest coplanar with an underlying surface when in use.

### BRIEF DESCRIPTION OF THE DRAWINGS

Preferred embodiments of the present invention are described below with reference to the accompanying illustrations in which:

FIG. 1a is a perspective view of the Pickens portable motorcycle jack arrangement;

FIG. 1b is a perspective view of the Hunt portable motorcycle jack arrangement;

FIG. 2 is a perspective view of an exemplary portable motorcycle jack in an extended configuration;

FIG. 3 is a perspective view of the portable motorcycle jack of FIG. 2 in a folded configuration;

FIG. 4 is a side elevation view of the portable motorcycle jack of FIG. 2 in a folded configuration;

FIG. 5 is a side elevation view of the portable motorcycle jack of FIG. 2 folded and adjusted to a shorter length;

FIG. 6a is a side elevation view of the portable motorcycle jack of FIG. 2 in an extended configuration adjusted to a first length;

FIG. 6b is a side elevation view of the portable motorcycle jack of FIG. 6a adjusted to a second length;

FIG. 6c is a side elevation view of the portable motorcycle jack of FIG. 6a adjusted to a third length;

FIG. 6d is a side elevation view of the portable motorcycle jack of FIG. 6a adjusted to a fourth length;

FIG. 7 is a side elevation view of the portable motorcycle jack of FIG. 2 prior to full engagement with a motorcycle;

FIG. 8 is a side elevation view of the portable motorcycle jack of FIG. 2 in use;

FIG. 9 is an enlargement of the encircled portion of FIG. 8;

FIG. 10 is a rear perspective view from above of the portable motorcycle jack of FIG. 2 In use;

FIG. 11 is a side elevation view showing the portable motorcycle jack of FIG. 2 prior to and following engagement;

FIG. 12 is a side elevation view of an exemplary portable motorcycle jack in an extended position;

FIG. 13 is a top perspective view of an exemplary lift arm having a cradle rotatable in an arcuate path from the lift arm;

FIG. 14 is a front elevation view of the lift arm and cradle of FIG. 13;

FIG. 15 is a front elevation view of the lift arm of FIG. 13 with the cradle rotated to one side;

FIG. 16 is a front elevation view of the lift arm of FIG. 13 with the cradle rotated to another side;

FIG. 17 is a top perspective view of an exemplary Y-shaped cradle integral with a lift arm;

FIG. 18 is a front elevation view of the cradle and lift arm of FIG. 17;

FIG. 19 is a side elevation view of the cradle and lift arm of FIG. 7;

FIG. 20 is an enlarged top perspective view of the cradle and the top of the lift arm of FIG. 17 engaging a spool of a motorcycle swing arm;

FIG. 21 is a side elevation view of the cradle, lift arm, and spool of FIG. 20;

FIG. 22a is front right perspective view of an exemplary insertable cradle having a bearing and lift arm;

FIG. 22b is an front left perspective view of the insertable cradle of FIG. 22a;

FIG. 23a is a rear right perspective view of the insertable cradle of FIG. 22a;

FIG. 23b is an rear left perspective view of the insertable cradle of FIG. 22a;

FIG. 24a a right side elevation view of the insertable cradle of FIG. 22a;

FIG. 24b is a left side elevation view of the insertable cradle of FIG. 22a;

FIG. 24c is a rear elevation view of the insertable cradle of FIG. 22a;

FIG. 24d is a front elevation view of the insertable cradle of FIG. 22a;

FIG. 25 is a top plan view of the insertable cradle of FIG. 22a;

FIG. 26 is a perspective view of an alternate embodiment of a portable motorcycle jack showing hingedly connected tubular members;

FIG. 27 is a rear perspective view of an alternate embodiment of a portable motorcycle jack having a pivoting foot in use;

FIG. 28a is a rear perspective exploded view of the portable motorcycle jack of FIG. 27;

FIG. 28b is a front perspective exploded view of the portable motorcycle jack of FIG. 27;

FIG. 28c is a rear perspective view of the portable motorcycle jack of FIG. 27 in an extended position;

FIG. 28d is a front perspective view of the portable motorcycle jack of FIG. 27 in an extended position;

FIG. 28e is a rear perspective view of the portable motorcycle jack of FIG. 27 in a folded position;

FIG. 28f is a front perspective view of the portable motorcycle jack of FIG. 27 in a folded position;

FIG. 29a is a front perspective view of an alternate embodiment of the portable motorcycle jack in an extended position preparing to receive a locking pin;

FIG. 29b is a rear perspective view of the portable motorcycle jack of FIG. 29a;

FIG. 30a is a front perspective view of the portable motorcycle jack of FIG. 29a having a locking pin inserted; and

FIG. 30b is a rear perspective view of the portable motorcycle jack of FIG. 29a having a locking pin inserted;

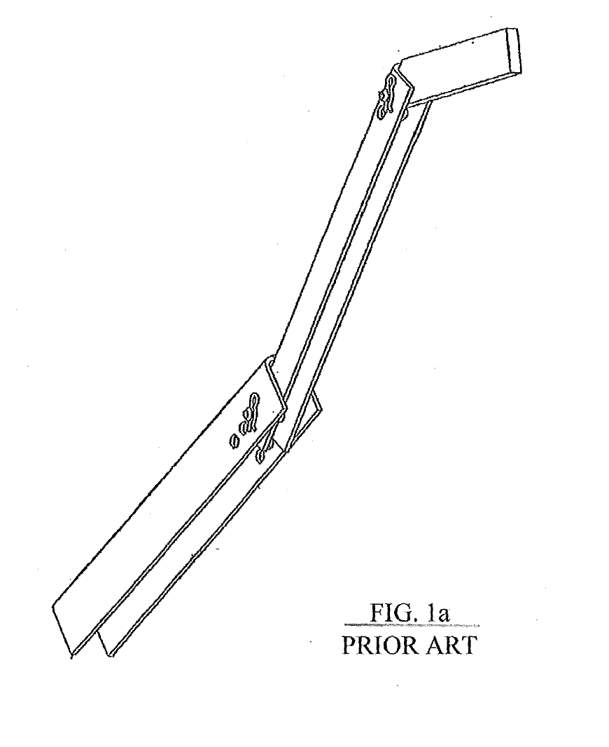

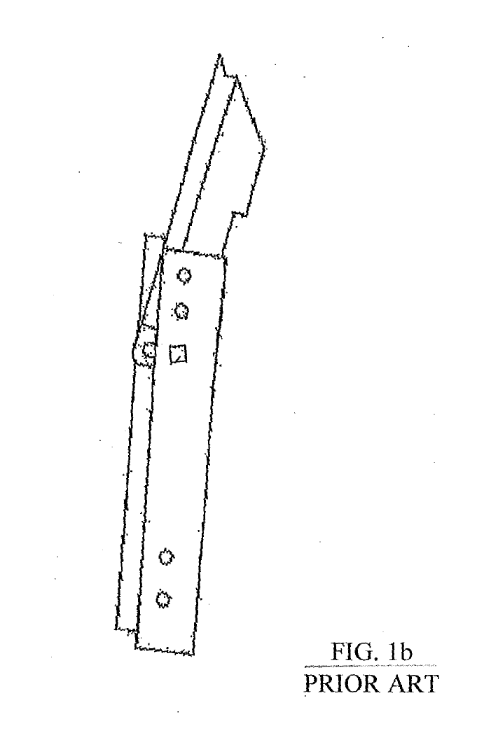

### DETAILED DESCRIPTION

One or more currently preferred embodiments have been described by way of example.

The present invention provides a portable motorcycle jack indicated generally by the reference numeral 100 in the accompanying figures. The motorcycle jack 100 has a base arm 102 hingedly attached to a lift arm 120. In use, the base arm 102 rests on the ground, and the lift arm 120 engages with the motorcycle.

In one embodiment, the base arm 102 is of a generally U-channel shape with a base web 104 from which opposing sides 106 extend. The base arm 102 further has at least one foot II0 that rests co-planar with the ground when the motorcycle jack 100 is in use. In one embodiment, not shown, the foot 110 may extend from the base web 104 and the sides 106. In another embodiment, the at least one foot 110 may extend simply from the base web 104. In an alternative embodiment, shown in the accompanying figures, the at least one foot 110 may be more accurately described as feet that extend from the sides 106 but not the web 104 of the base arm 102. The foot 110 may extend in any other variation from the base arm 102 towards the ground that permits it to be co-planar with the ground when in use.

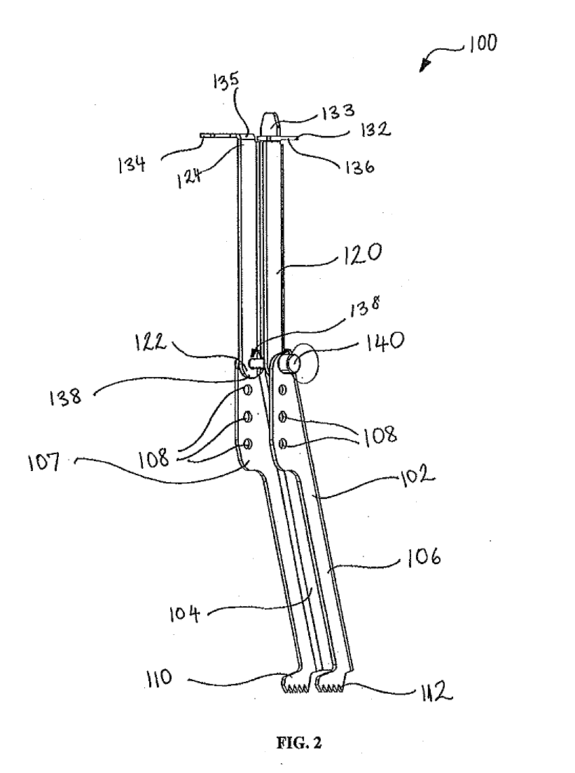

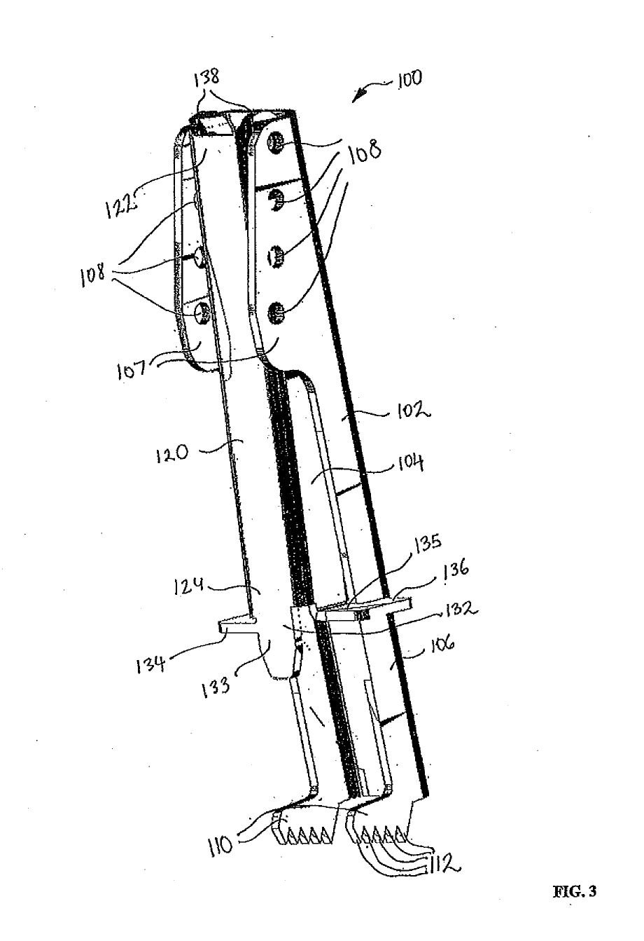

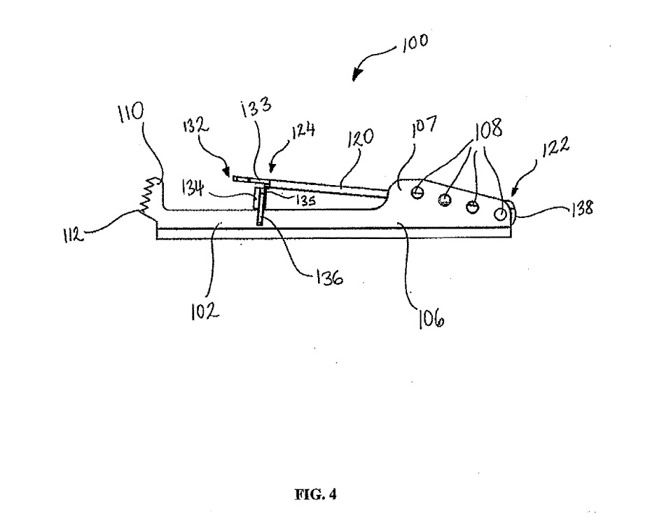

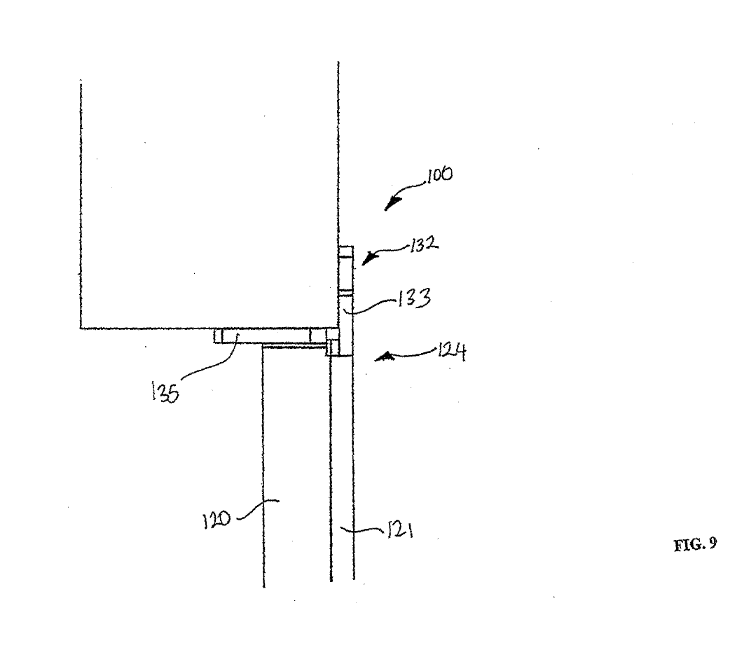

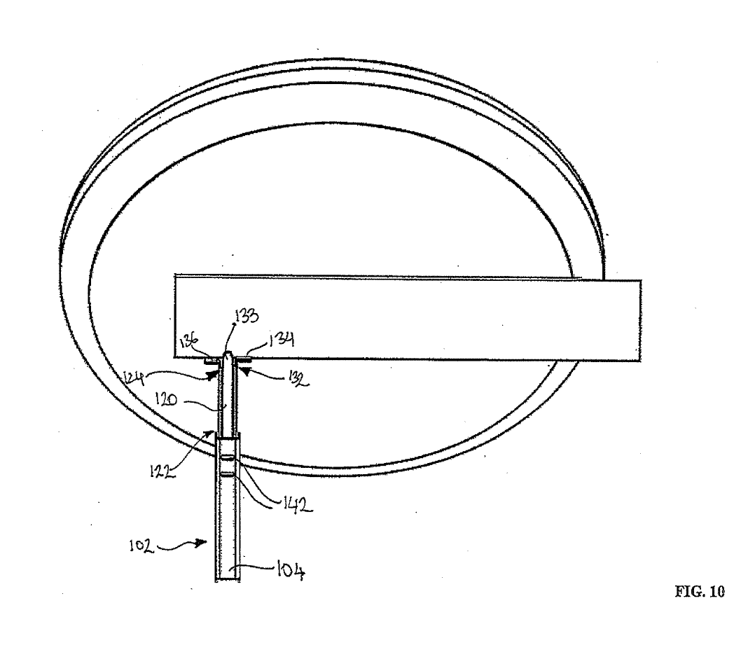

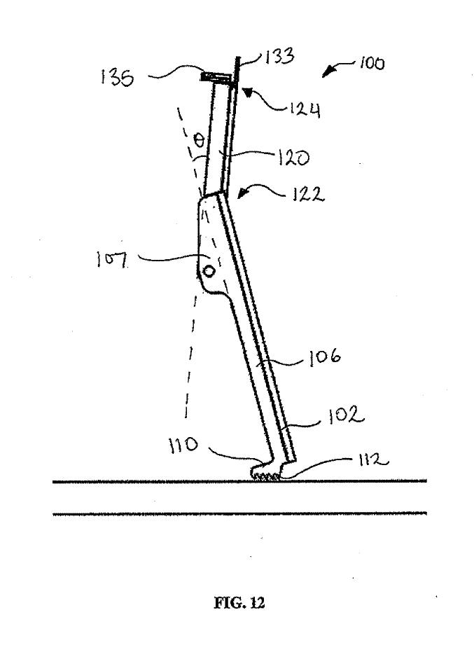

Additionally, the foot 110 may have teeth 112 as shown in the accompanying FIGS. 2-12 to provide a grip for multiple flooring types. Use of a suitable material, such as high strength low alloy (HSLA) steel rather than a soft aluminum also limits wearing the grip provided by the teeth 112. Thus, the teeth 112 may be used to grip smooth surfaces and prevent the unit from sliding. They may also be used for rough surfaces. For example, the teeth 112 may be used on smooth concrete, asphalt, painted and epoxy flooring among other flooring types. Additionally, the foot 110 may be padded to prevent damage to floors such as epoxy floors, polished floors, and painted floors.

The lift arm 120 is hinged to the base arm 102 in a way that permits it to pivot from a folded position (FIGS. 3, 4, and 5), in which the lift arm 120 is contained within the base arm 102, to an extended position (FIGS. 2 and 6a-8) in which the lift arm 120 is hyperextended outwardly to an over-fulcrum angle e defined by the relative position of the longitudinal axis of lift arm 120 to the longitudinal axis of the base mm 102 for supporting the rear wheel of the motorcycle.

Hinging of the lift arm 120 to the base arm 102 may be accomplished by the use of a clevis pin. Alternate attachment means are also possible such as a spring loaded ball bearing or other means known to one skilled in the art. In the accompanying figures, a pivot pin 140 mounts the lift arm 120 within the base arm 102. Accordingly, the base arm 102 has a series of apertures 108 for receiving the pivot pin 140. Although four pairs of apertures 108 are shown in the accompanying figures, one two, three, five or any suitable number of apertures 108 may be used. In the accompanying figures, the apertures 108 are shown to be linearly arranged on a slope relative to the length of the base arm 102. The use of multiple pairs of apertures 108 permits the length of the motorcycle jack 100 to be adjusted for varying heights of motorcycle swing arms relative to the ground. To enable length adjustment, a cotterless hitch pin with a spring activated locking method may be used. Other means of fixing the unit at different lengths may be also be used as will be known to the those skilled in the art. Although nuts, bolts, washers and the like may be used, these are less preferred.

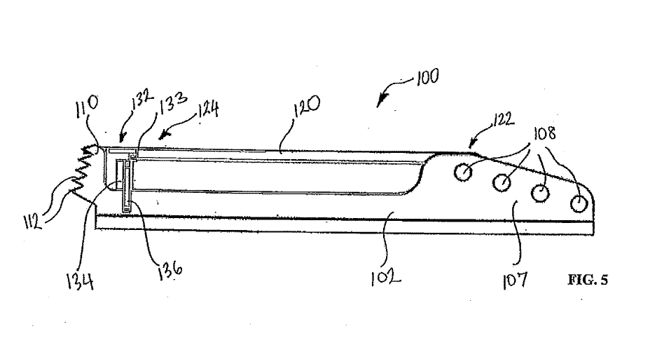

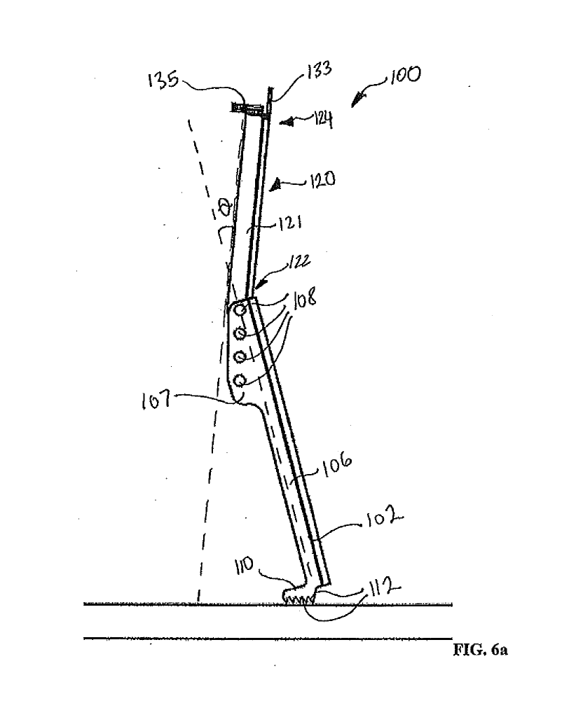

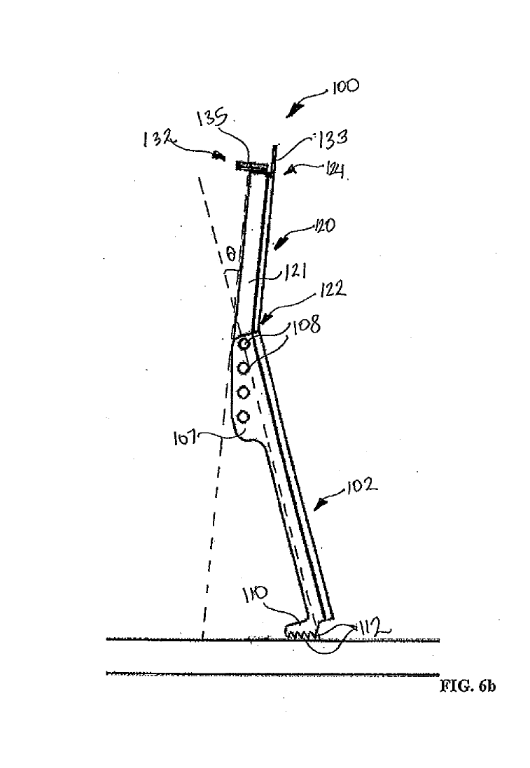

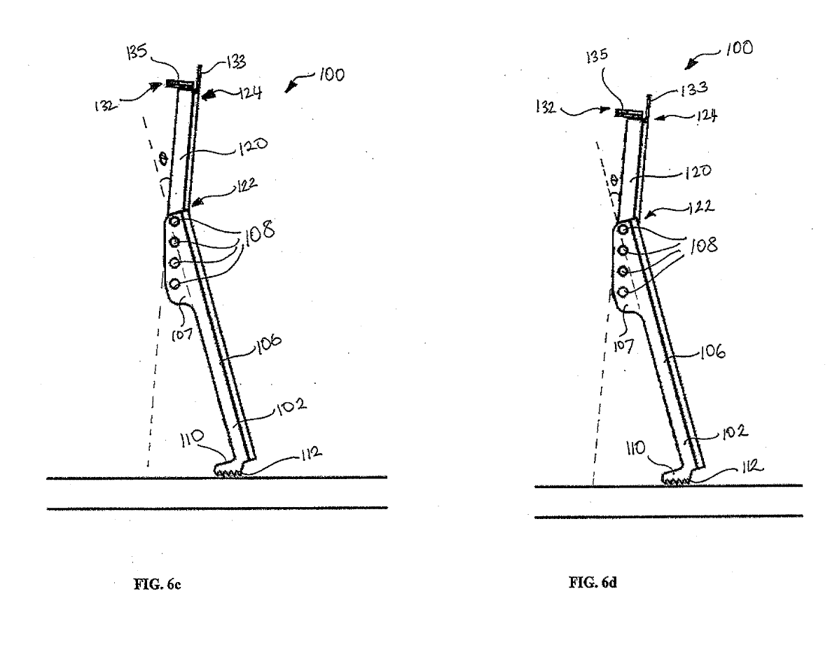

The sloping of the apertures 108 permits the over-fulcrum angle e of the motorcycle jack 100, when extended, to remain substantially the same regardless of which length or aperture pair 108 is selected. For example, FIGS. 6a, 6b, 6c, and 6d show the motorcycle jack 100 in an extended position wherein the over-fulcrum angle e of the longitudinal axis of lift arm 120 relative to the longitudinal axis of the base arm 102 remains substantially the same at extension despite the use of different apertures 108 for length adjustment. In the extended position, the over-fulcrum angle 8 should be between 10 to 20 degrees to provide stabilization of the motorcycle jack 100, preferably between 15 to 20 degrees. In the accompanying figures, the region 107 of the sides 106 having the apertures 108 is made larger and obliquely angled relative to the length of the base arm 102 to accommodate the number and sloping of the linearly arranged apertures 108. Although this is preferred for economical fabrication, it is contemplated that the entire base arm 102 could be made larger or any portion of the base arm 102 could have differing dimensions to accommodate the apertures 108.

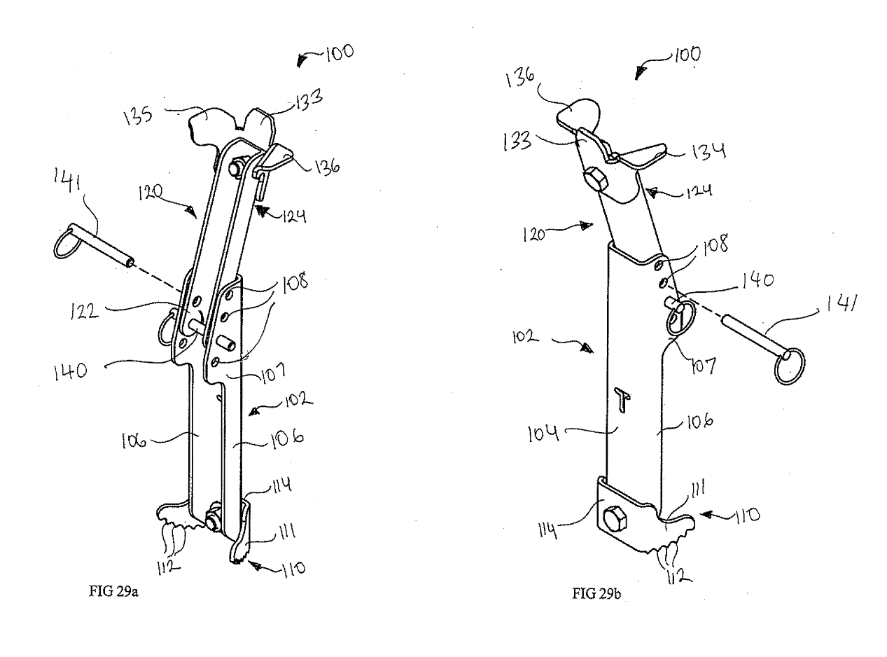

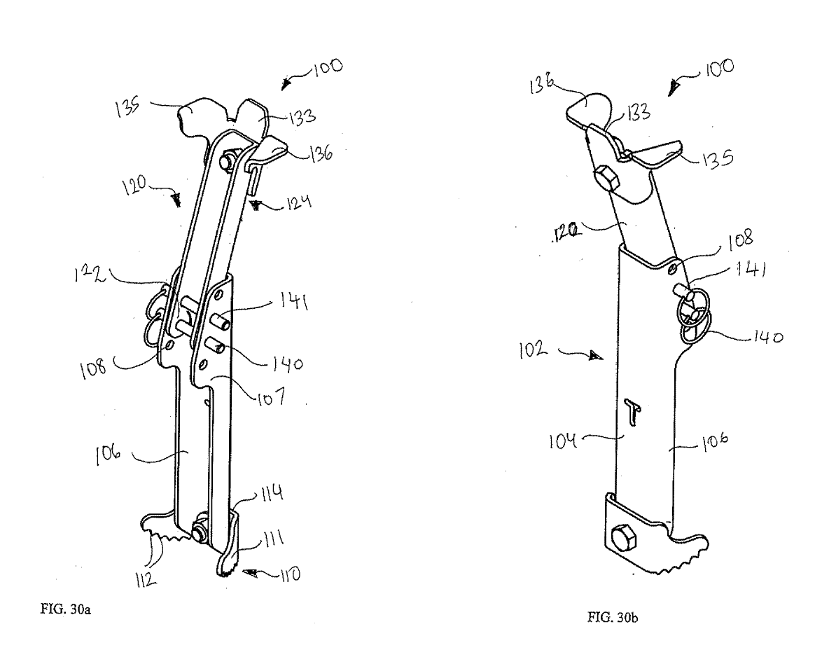

In order to hinge the lift arm 120, the pivot pin 140 that extends through the apertures 108 also extends through holes 130 in a base end 122 of the lift arm 120. Because adjustment is contemplated along the base arm 102, only one pair of holes 130 is shown in the accompanying figures for the lift arm 120. However, it is possible to have multiple pairs of holes 130 in the lift arm 120 along with multiple pairs of apertures in the base arm 102. Indeed, it may be desirable to have multiple pairs of holes 130 as shown in FIGS. 29a-30b for insertion of a locking pin 141 as discussed below. It is also possible to have linearly arranged holes sloping along the lift arm 120 for adjustment along the lift arm 120 and one pair of apertures in the base arm 102 or any other combination as will be known to one skilled in the art.

The lift arm 120 has a body 121 having an cradle end 124. The base end 122 of the lift arm 120 attaches to the sides 106 of the base arm 102. A cradle 132 extends from the cradle end 124 of the lift arm 120 for engaging the swing arm of the motorcycle. As shown in FIGS. 2-12, the cradle 132 may in one embodiment comprise a seat portion 135 and a back portion 133 to hold the swing arm of the motorcycle. In this embodiment, the back portion 133 extends in the same direction as the lift arm 120 whereas the seat portion 135 extends generally perpendicularly from the lift arm 120 and back portion 133. In FIGS. 2-12, the cradle 132 has a first portion 134 and a second portion 136 that are staggered in height relative to each other. The staggering of the first and second portions respectively 134, 136 accommodates the common design of rear swing arms of motorcycles that are generally angled downward toward the rear of the motorcycle. However, other variations of a cradle are envisioned to accommodate variations in designs of the swing arm. For example, the first portion and the second portion may not be staggered if the rear swing arm of a motorcycle does not slope downwardly.

In other embodiments, the cradle may be rotatably attached to the cradle end of the lift arm for accommodating the swing arm on the motorcycle. For example, as shown in FIG. 13-16, or 28a-28d, the cradle 232 may be rotatably attached to the cradle end 124 of the lift arm 120 for rotating in an arcuate path from the lift arm 120 to engage with the swingarm on the motorcycle. Thus, this design may accommodate various degrees of sloping of the motorcycle swing arm. To accomplish such rotatable movement along the arcuate path, the cradle 232 may be bolted, riveted, or otherwise rotatably secured to the cradle end 124 of the lift arm 120 as will be known to one with skill in the art.

When not in use, the cradle 232 may take the position shown in FIG. 14. The cradle 232 may rotate in an arcuate path relative to its engagement with the lift arm 120 and may halt rotation upon its registration with.the body 121 of the lift arm 120. For example, as shown in FIG. 15, the registration of the first portion 234 with the body 121 of the lift arm 120 acts as a stop for the rotation of the cradle 232 relative to the lift arm 120. Similarly, as shown in FIG. 16, the registration of the second portion 236 with the body 121 of the lift arm 120 acts as a stop for the rotation of the cradle 232 relative to the lift arm 120. In the illustrated embodiments, the cradle rotates 20 to 25 degrees from the longitudinal axis of the lift arm before it is limited by the body 121 of the lift mm 120. However, this angle may be modified by increasing or decreasing the distance between the body 121 of the lift arm 120 and the cradle 232 so that the angle of rotation from the longitudinal axis or the arcuate path is either increased or decreased, respectively.

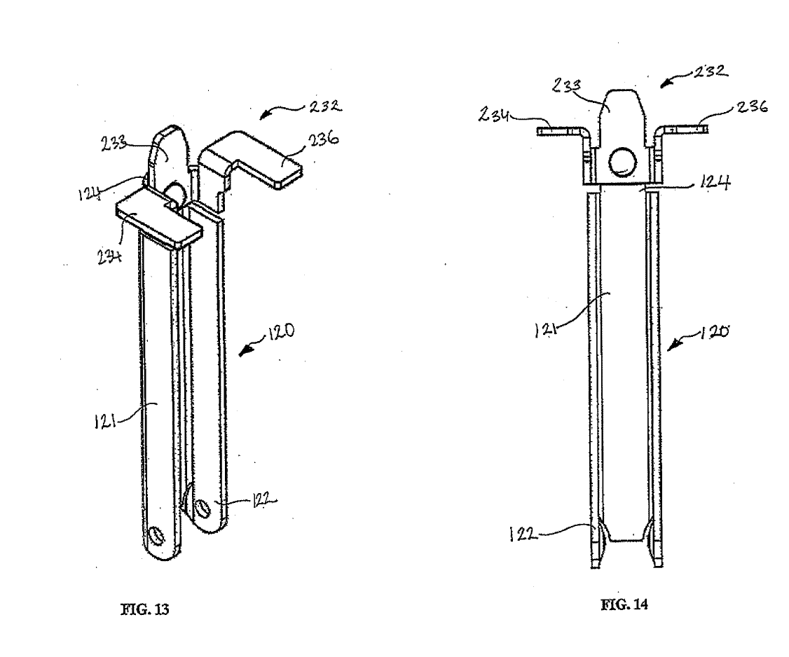

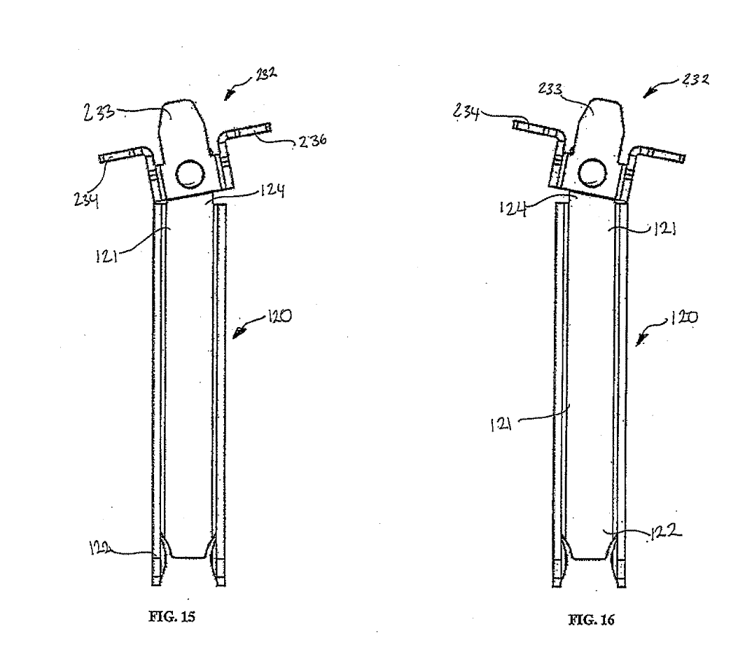

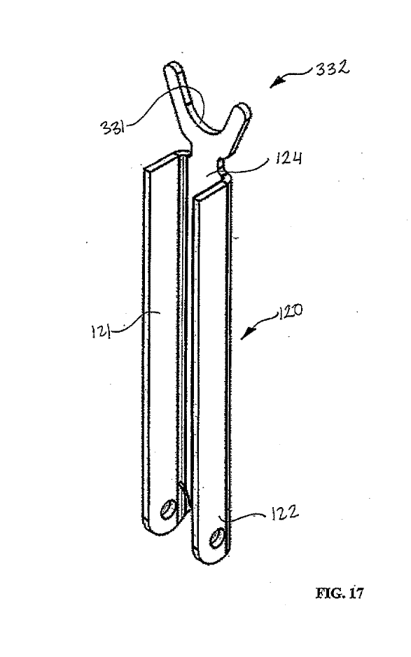

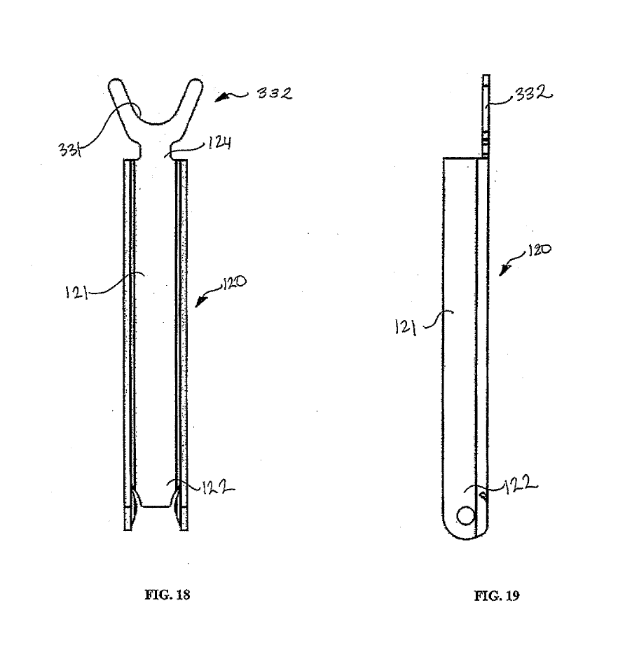

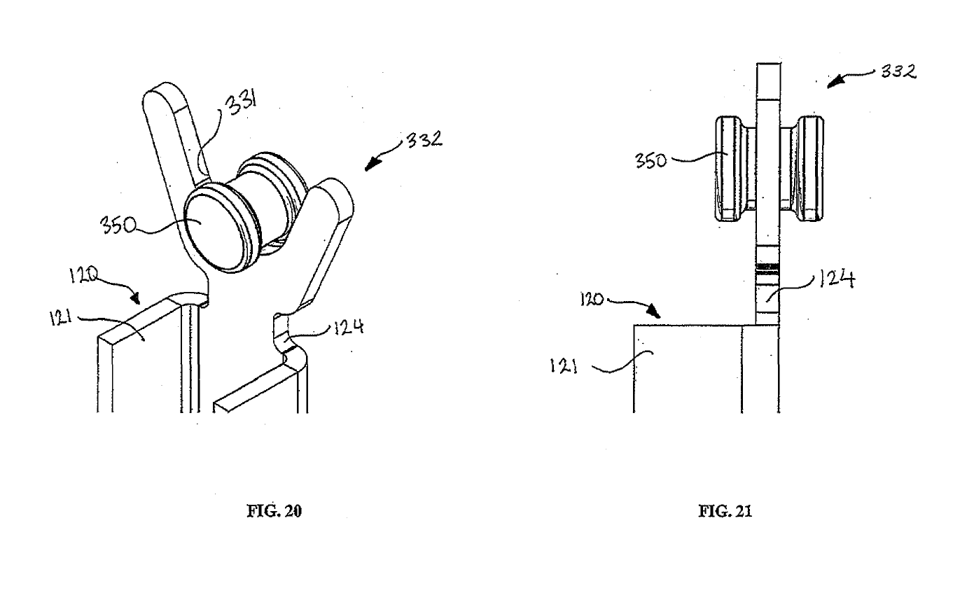

In another embodiment, the cradle may have a receiving portion for receiving a corresponding protrusion such as a bolt extending from the motorcycle swing arm. For example, as shown in FIGS. 17-21, the cradle 332 is a Y-shaped piece integral with the lift arm 120. In this embodiment, the cradle 332 has a receiving portion 331 that is a cut-out for receiving a corresponding protrusion. The protrusion may already extend from the motorcycle swing arm or may be added to the motorcycle swing arm for being received in the cut-out portion 331. For example, as shown in FIGS. 20 and 21, a spool is the protrusion 350 being received in the receiving portion 331. Alternatively, the protrusion 350 may be a bobbin or pin or any other suitable protrusion as will be known to one with skill in the art. Although the cradle 332 is shown as a Y-shaped piece integral with the lift arm, it may be a U shaped piece, a ring, or of any suitable shape having a receiving portion capable of receiving a corresponding protrusion. Further, the receiving portion 331 may be a cut-out portion or a recessed portion for receiving the corresponding protrusion. In any of these instances, the cradle 332 may be integral with or attached to the lift arm 120.

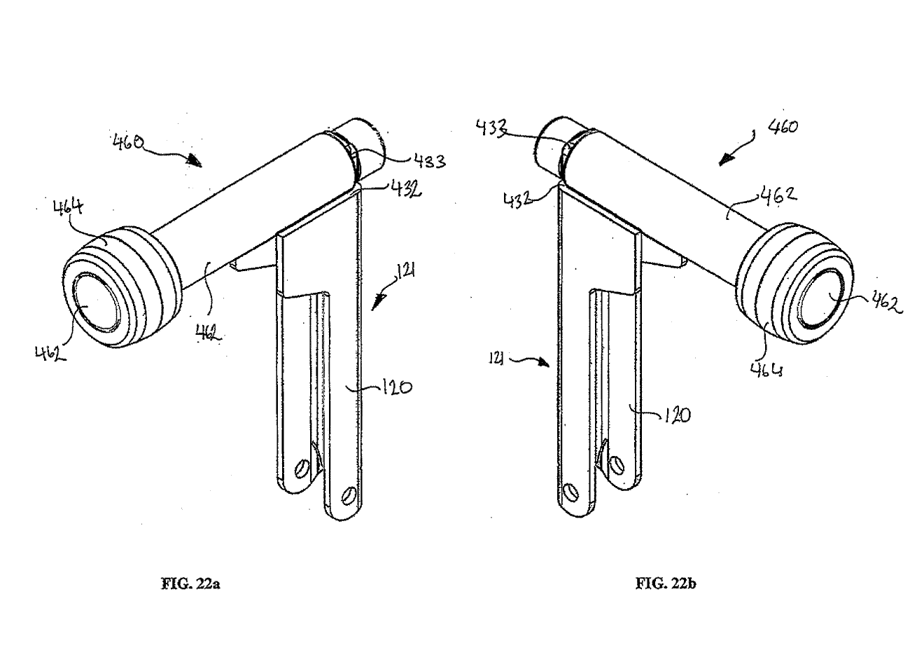

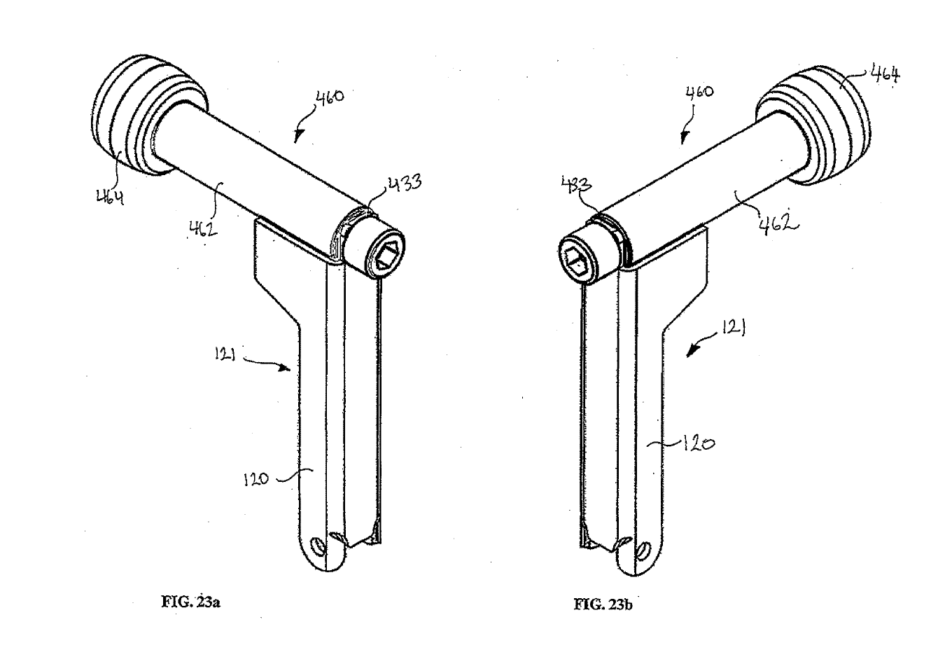

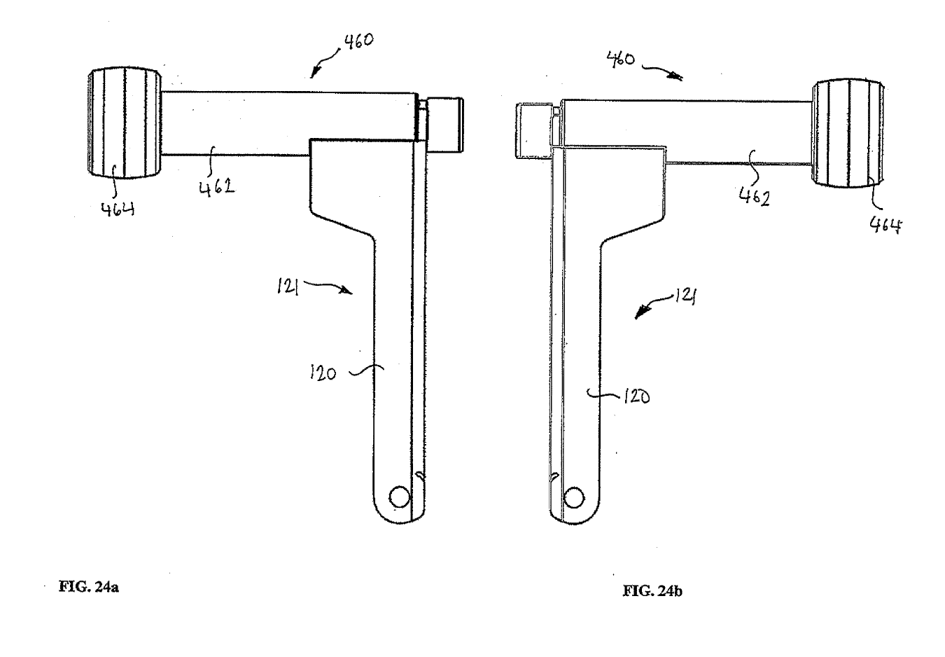

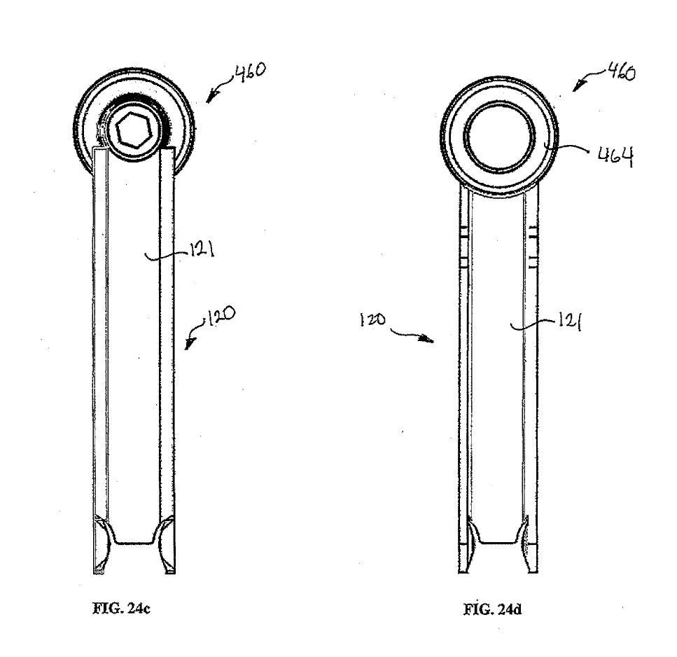

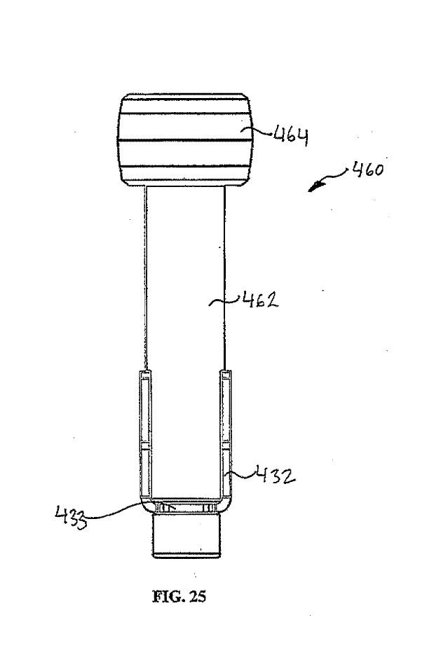

In still another embodiment, the cradle may have an insertable portion for insertion into a hollow rear axle of a motorcycle. For example, as shown in FIGS. 22a-25, the cradle 432 has an insertable portion 460 for insertion into a hollow rear axle of a motorcycle. The insertable portion 460 is comprised of tubular portion 462 having a rotatable head 464 insertable into the hollow rear axle. The rotatable head 464 permits rotation of the motorcycle rear wheel without spinning the portable motorcycle jack. The head 464 may be made of Teflon, polyurethane, or any other suitable material to limit damage to the axle of the wheel when inserted. The cradle 432 and lift arm 121 may be integral or attached. In the accompanying drawings, the insertable portion 460 is attached to the cradle 433 by a pin inserted through the back portion 432 and into the tubular portion 460. It may be formed integrally with the cradle 433 or otherwise attached as will be apparent to one with skill in the mi. It is envisioned that this motorcycle jack may be used with double or single-sided swing arms.

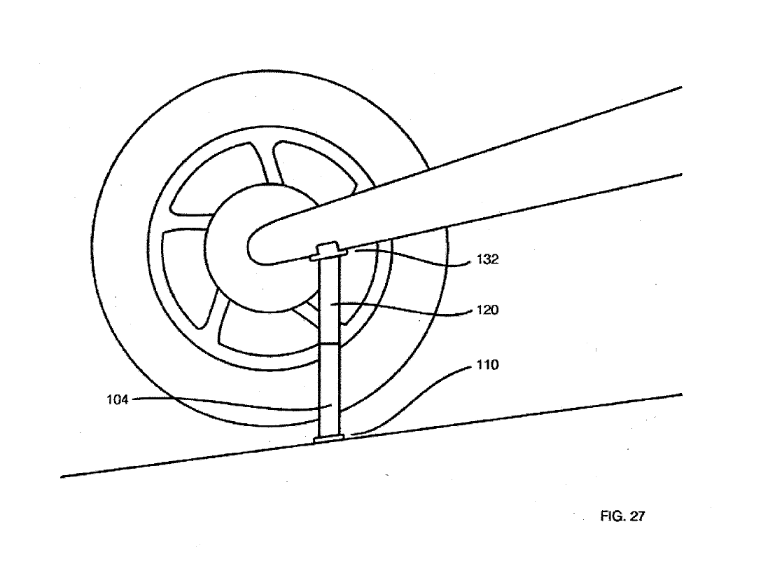

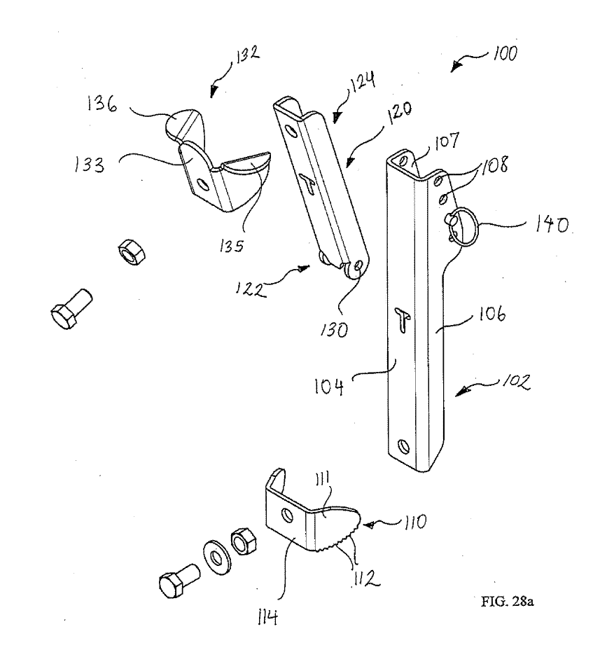

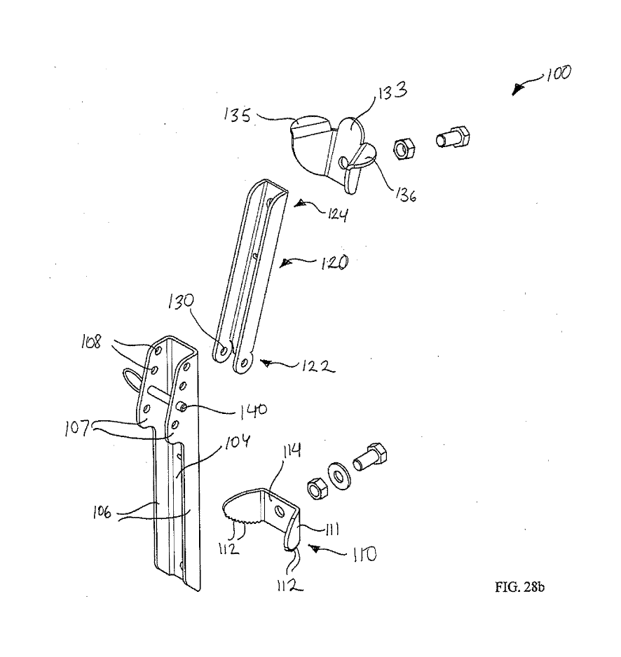

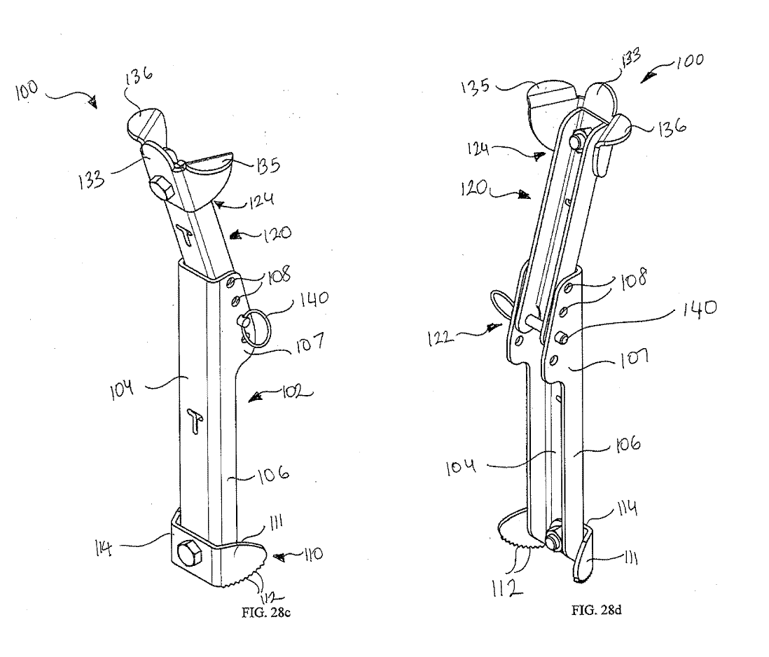

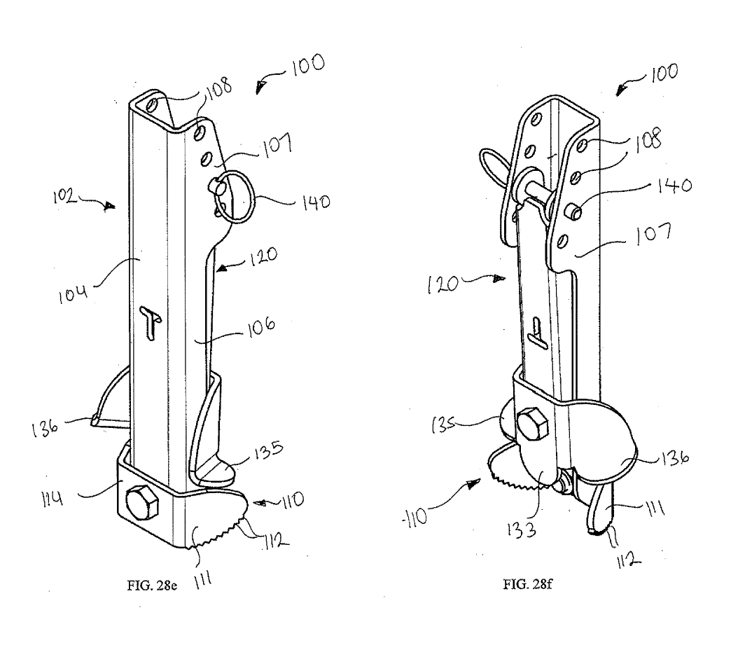

Similarly, the foot 110 may be pivotally joined to allow for arcuate rotation relative to a surface. For example, as shown in FIG. 27, the foot 110 is pivoted to allow for contact with a sloping or uneven ground. In this embodiment, the motorcycle jack 100 can lean rather than slide under the weight of the motorcycle. Thus, as shown in FIGS. 27-30b, the feet 110 may extend from legs 111 that themselves extend from a back 114 that is pivotally joined to the base web 104. For example, as shown in FIGS. 28a and 28b, the back 114 may have an aperture 116 for receiving a fastener 118 that extends through an aperture in the base web 104 for pivoting connection. Although the legs I11 are shown on the exterior surface embracing the base arm 102, they may instead be on the interior surface so that the legs 111 are embraced by the base arm 102. Any suitable pivoting means are envisioned as will be known to one with skill in the art.

In the accompanying figures, the lift arm 120 is shown to be a U-channel shape. It may, however, have other shapes such as a generally rectangular prism or a cylinder or any other suitable shape that supports a cradle 132 and hingedly joins to the base arm 102. It may be a solid or hollow so long as the holes 130 are present to permit engagement of the pivot pin 140. The U-channel shape is the preferred embodiment for economical fabrication of the motorcycle jack 100.

The lift arm 120 further has rounded edges 138 along the base end 122 to permit the hinged rotation of the lift arm 120 within the base mm 102 without obstruction. The web 104 may also or instead be cut away to permit such unobstructed rotation.

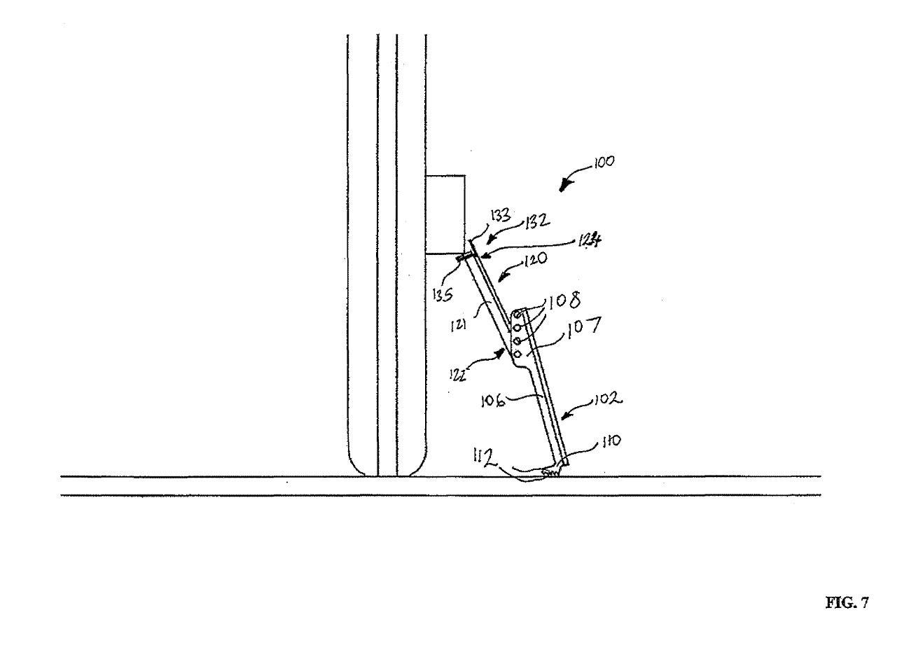

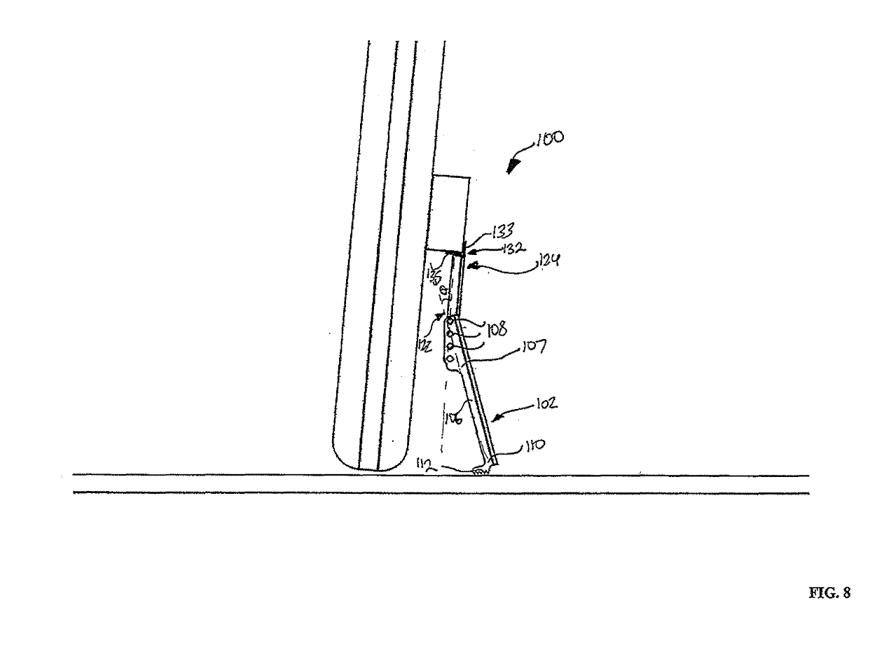

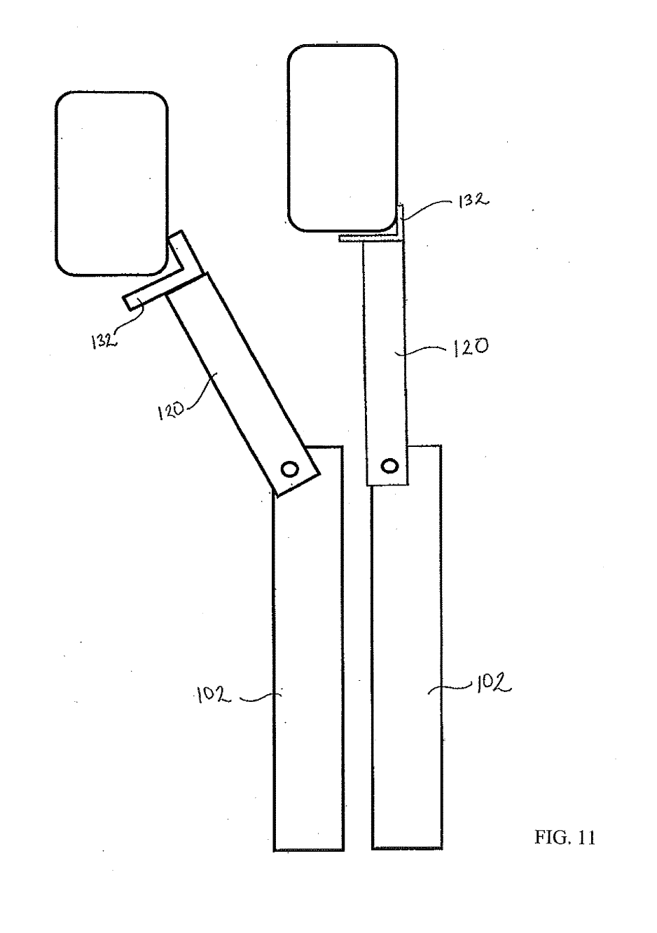

FIG. 7 illustrates an embodiment of the present invention prior to full engagement with the motorcycle. At the desired adjusted height, the motorcycle jack 100 is unfolded from its folded compact condition but not hyper-extended as when fully engaged. The base arm 102 is placed with the foot 110 co-planar or flush with the ground, and the cradle 132 is placed around the motorcycle swing arm. The motorcycle is resting on its kickstand and front and rear tires. Once in position, the base arm 102 can be kicked, pushed, or otherwise urged inward or toward the motorcycle. The teeth 112 on the foot 110 help hold the base mm 102 to the ground. By operation of the hinge joint, pushing the base arm 102 inwardly pushes the lift mm 120 outwardly such that the lift arm 120 is hyperextended as shown in FIG. 8 relative to the base arm 102 in its pre-engagement position, and in conjunction with the opposing force provided by the motorcycle kickstand, thereby shifts the weight upwards and lifts the rear wheel (FIG. 11).

In another embodiment, as shown in FIGS. 29a-30b, a locking pin 141 may be inserted through another pair of apertures 108 to retain the motorcycle jack 100 in its hyper-extended position. While the pivot pin 140 provides a hinged joint for folding and unfolding the motorcycle jack 100, the locking pin 141 limits further movement by limiting hinged rotation. Thus, the motorcycle jack 100 can remain in the hyperextended position limiting unintentional folding of the motorcycle jack 100 when in use. The locking pin 141 may take the form of the pivot pin 140 as described above. Although the pivot pin 140 and the locking pin 141 are shown to have a ring 143 for ease of gripping and removal, other grips may also be used. For example, the pivot pin 140 and/or the locking pin 141 may have indentations, ribbing, or rubber padding at their ends for ease of holding the pins 140, 141. Other locking pins or gripping means will be known to one with skill in the art.

To disengage, the motorcycle jack 100 is simply returned to the pre-engagement position shown in FIG. 7. An attachment (not shown) may be further be provided that extends from the base arm 102 to enable safe disengagement from the motorcycle. This attachment may be a strap that is threaded through slotted apertures 142 in the base arm 102 or otherwise attached in the base arm 102 and facing outwardly or away from the motorcycle. The strap or other attachment may simply be pulled to disengage the motorcycle jack more safely from the kickstand. The motorcycle jack may then be folded for compact storage.

The motorcycle jack 100 may be made of metal, stainless steel, high strength low alloy steel, other alloys, or other materials that provide a suitable strength to weight ratio.

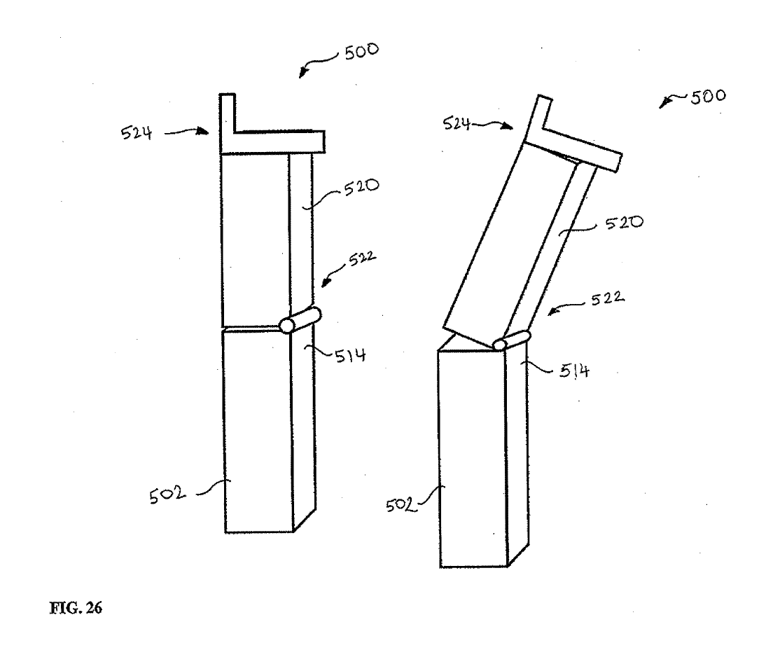

In another embodiment, the present disclosure provides a portable motorcycle jack 500 for supporting a rear wheel of a motorcycle as shown in, for example, FIG. 26. The portable motorcycle jack 500 has a base arm 502 hingedly connected at one end 514 to a lift arm 520 at a base end of the base arm for hinged rotation between a folded non-deployed position and a deployed position in which the lift arm 520 and the base arm 502 define an over-fulcrum angle to maintain the portable motorcycle jack 500 in the deployed configuration in response to a weight of the motorcycle acting on a cradle end 524 of the lift arm which is opposite said base end 502. A cradle is connected to the cradle end 524 for supporting the swing arm of the motorcycle, and a foot on the base arm 502 opposite the one end 514 is configured to rest coplanar with an underlying surface when in use.

As the accompanying illustrations show the device in use with a rear wheel, the device is described throughout the specification with respect to a rear wheel use. However, this is not intended to be limiting as the device can be configured for use with a front or rear wheel of a motorcycle.

The scope of the claims should not be limited by the preferred embodiments set forth in the examples but should be given the broadest interpretation consistent with the description as a whole.

Parts List

| | |
|---|---|
| 100 | motorcycle jack |
| 102 | base arm |
| 104 | base web |
| 106 | side |
| 107 | region |
| 108 | aperture |
| 110 | foot |
| 111 | legs |
| 112 | teeth |
| 114 | back |
| 116 | back aperture |
| 118 | base web aperture |
| 120 | lift arm |
| 121 | body |
| 122 | base end |
| 124 | cradle end |
| 130 | holes |
| 132, 232 | cradle |
| 332, 432 | |
| 133, 433 | back portion |
| 134 | first portion |
| 135 | seat portion |
| 136 | second portion |
| 138 | rounded edges |
| 140 | pivot pin |
| 141 | locking pin |
| 142 | slotted apertures |
| 331 | cut-out portion |
| 350 | protrusion |
| 460 | insertable portion |
| 462 | tubular portion |
| 464 | rotatable head |
| 500 | motorcycle jack |
| 502 | base arm |
| 514 | one end |
| 520 | lift arm |
| 522 | base end |

1. A portable motorcycle jack for supporting a wheel of a motorcycle, the portable motorcycle jack comprising:
a U channel base arm having a web and two side flanges;
a lift arm defined by a body having a base end and an cradle end, and hinged at said base end to said two side flanges of said base arm providing a hinged joint;
a pivot pin mounting said lift arm within said base arm for hinged rotation between a folded position in which said lift arm is contained within said base arm and a hyper-extended position in which said lift arm moves over said hinged joint to extend outwardly from said base arm to an over-fulcrum angle defined by the relative position of the longitudinal axis of said lift arm to the longitudinal axis of said base arm for supporting the rear wheel of the motorcycle;
a cradle rotatably attached to said cradle end of said lift arm for engaging the motorcycle; and
said base arm having a foot rotatably attached thereto for accommodating various surface configurations of the ground on which the foot may rest when in use.

2. The portable motorcycle jack as claimed in claim 1, wherein said cradle is rotatably attached to said cradle end of said lift arm for engaging a swing arm on the motorcycle and accommodating various degrees of swing arm angles.

3. The portable motorcycle jack as claimed in claim 2, wherein said cradle is rotatably attached to said cradle end of said lift arm for rotating in an arcuate path from the cradle end of the lift arm to engage with the swing arm on the motorcycle.

4. (canceled)

5. (canceled)

6. The portable motorcycle jack as claimed in claim 1, wherein said cradle has an insertable portion for insertion into a passage extending into an axle of the motorcycle.

7. The portable motorcycle jack of claim 6, wherein said insertable portion includes a head rotatably attached thereto for supporting said axle for rotation along with said wheel.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)
